(19) United States
(12) Patent Application Publication
(10) Pub. No.: US 2010/0170936 A1
(43) Pub. Date: Jul. 8, 2010

(54) METHOD FOR BONDING TWO MATERIALS

(75) Inventors: PO MIN TU, CHIAYI COUNTY (TW); SHIH CHENG HUANG, HSINCHU CITY (TW); YING CHAO YEH, TAIPEI COUNTY (TW); WEN YU LIN, TAICHUNG COUNTY (TW); PENG YI WU, TAICHUNG CITY (TW); SHIH HSIUNG CHAN, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED OPTOELECTRONIC TECHNOLOGY INC., HSINCHU COUNTY (TW)

(21) Appl. No.: 12/650,056

(22) Filed: Dec. 30, 2009

(30) Foreign Application Priority Data
Jan. 7, 2009 (TW) 098100292

(51) Int. Cl. B23K 31/02

(52) U.S. Cl. 228/121

(57) ABSTRACT

A method for bonding two materials uses radio frequency energy to swiftly induce heat in a high permeability material for heating a medium to the bonding temperature of the medium so as to bond the two materials with each other.

### BACKGROUND OF THE INVENTION

1. Field of the Invention

The present invention relates to a bonding method, and relates more particularly to a method for bonding two materials, which uses a radio frequency heating system to facilitate the bonding of the two materials.

2. Description of the Related Art

In a semiconductor method for manufacturing a light emitting diode, the epitaxial process, performed with other processes, uses a substrate, to which a GaN (gallium nitride) crystal can attach, for depositing an epitaxial layer on the substrate. The main considerations of the adoption of a substrate for the deposition process are the degree of the match of the lattice constants of the substrate and the epitaxial layer, and the match of the coefficients of thermal expansion of the substrate and the epitaxial layer. With matched lattice constants and coefficients of thermal expansion, the epitaxial layer is able to grow on the substrate. However, the substrate lattice matched to the epitaxial layer usually has poor electrical and thermal conductivity so that after the epitaxial process is performed, a conductive material is attached to the epitaxial layer as electrodes. The bonding of the epitaxial layer and the conductive material is a heterogeneous bonding, which may have an adverse influence on the quality of the light emitting diodes.

As to the bonding of heterogeneous materials, conventional bonding methods are applied. U.S. Pat. No. 7,371,661 issued to Chun-Hao Chang et al. discloses a method using thermal ultrasonic energy to bond an epitaxial layer to a conductive material such as metal. Between the epitaxial layer and the conductive material, a medium layer is disposed. The medium layer can be activated by ultrasonic oscillation. The surface molecules are oscillated so as to generate a molecular bonding force, by which the epitaxial layer and the conductive material are bonded. The bonding method can bond the epitaxial layer and the conductive material at a low temperature for a short time period. However, the oscillation induced by the thermal ultrasonic energy may cause the interface between the epitaxial layer and the conductive material to have incomplete bonding due to frictional oscillation. As a result, the manufacturing yield of light emitting diodes may be affected, and therefore a better method is needed.

Furthermore, U.S. Pat. No. 5,141,148 issued to Hideyuki Ichiyawa proposes a method for bonding heterogeneous materials. An anode and a cathode are oppositely disposed relative to the epitaxial layer and the conductive material. A DC voltage of 300-500 volts is applied across the anode and the cathode, and the bottom of the epitaxial layer is subjected to a high temperature. The epitaxial layer and the conductive material are bonded due to molecular bonding forces by electrical and thermal treatment. The method needs a high voltage power supply to supply a voltage of 300-500 volts, and needs to increase a working temperature to a level of 300-500 degrees Celsius so that the epitaxial layer and the conductive material can be effectively bonded. However, the epitaxial layer and the conductive material may easily crack at a lower environmental temperature due to the cooling shrinkage thereof. In addition, in the high voltage environment during bonding, electromagnetic field is created by accumulated electrical charges, causing high voltage difference across optoelectronic semiconductor devices and resulting in damage to the optoelectronic semiconductor devices. Consequently, the manufacturing yield of optoelectronic devices may be reduced, and therefore a better bonding method is needed.

U.S. Pat. No. 6,537,892 issued to Larry Lee Jordan et al. discloses a bonding method that uses a glass frit material as a medium material for bonding heterogeneous materials. The glass frit material can be configured to bond two heterogeneous wafers, a device wafer and a capping wafer. The glass frit material is slightly melted in a high temperature environment to bond the device wafer and the capping wafer. The molten glass frit material can accomplish firm bonding. After solidification of molten glass frit material, the device wafer and the capping wafer are spaced apart from one another with a certain gap. If the glass frit material is used to bond the epitaxial layer and the conductive material, the operating temperature must be increased to above 300 degrees Celsius to melt the glass frit material. Although the glass frit material can achieve firm bonding, bonded materials may suffer from cracking due to the cooling shrinkage thereof. Therefore, the glass frit material is not suitable as the bonding material to bond the epitaxial layer and the conductive material.

U.S. Pat. No. 5,403,916 issued to Masanori Watanabe et al. discloses a method that can directly bond two heterogeneous materials. The method can bond two heterogeneous semiconductor materials that cannot be easily bonded without using any material as the bonding medium. The method teaches that two semiconductor materials exposed to a high temperature environment are bonded by acting pressure force upon both. The two semiconductor materials are mutually fusion bonded due to the high temperature and the high pressure. Eventually, the two semiconductor materials are naturally and directly bonded. The method bonds two different semiconductor materials directly and depends on a high temperature. The method is suitable for bonding two different semiconductor materials that can endure high temperatures without deterioration. For the bonding of an epitaxial layer and a conductive material, the crystal lattice of the epitaxial layer may be damaged by high temperatures (900° C.), and the epitaxial layer may suffer from cracking due to the cooling shrinkage thereof. Therefore, the method is not suitable for a light emitting diode process.

U.S. Pat. No. 6,287,882 issued to Kuo-hsiung Chang et al. discloses a method that uses a medium layer to bond two different semiconductor materials to each other. The bonding method requires a high temperature environment so that the medium layer can exhibit bonding capability. In addition to the bonding method, a removal method is also disclosed for removing two bonded materials. The bonding method, mainly for light emitting diodes, can use a substrate with better conductivity in place of a substrate with low conductivity. Although the bonding method is suitable for light emitting diodes, the epitaxial layer cannot avoid cracking caused by the shrinkage thereof when the epitaxial layer is cooled from a high temperature to a low temperature. Moreover, an external force is required to remove the epitaxial layer from the substrate, to which the epitaxial layer is attached, and such a removal method may damage the epitaxial layer and lower the manufacturing yield of light emitting diodes.

### SUMMARY OF THE INVENTION

In accordance with the above-mentioned disadvantages of the prior art and the progress of the semiconductor process technology, the inventor proposes a bonding method for bonding two materials. The primary aspect of the present invention is that radio frequency heating is applied to a high magnetic permeability material to swiftly induce a large amount of heat such that the bonding medium can be heated to a bonding temperature to bond the two materials. The radio frequency heating method is based on the theory of magnetic inductance such that eddy currents are induced in the high magnetic permeability material when the high magnetic permeability material is subjected to a magnetic field. The heat is generated due to the eddy currents and the resistance of the material, sufficiently heating the medium material to the bonding temperature of the medium material.

The present invention is related to a method for bonding two materials. The method comprises the steps of: forming a high magnetic permeability metal layer on a first material layer; forming a medium layer on the high magnetic permeability metal layer; bringing a second material layer in contact with the medium layer; and inducing heat in the high magnetic permeability metal layer by radio frequency energy to heat the medium layer to a bonding temperature of the medium layer so as to bond the second material layer to the first material layer.

In addition, the present invention proposes another method, which comprises the steps of: forming a high magnetic permeability metal layer on a first material layer, and a medium layer on a second material layer; and bringing the high magnetic permeability metal layer in contact with the medium layer, and inducing heat in the high magnetic permeability metal layer by radio frequency energy to heat the medium layer to a bonding temperature of the medium layer so as to bond the second material layer to the first material layer.

In the above-mentioned methods, the material of the high magnetic permeability metal layer is iron, cobalt, nickel or an alloy thereof, and the medium layer is a medium metal layer. The material of the medium layer is indium, tin, zinc, silver, or an alloy thereof. The bonding temperature (which, on average, is below 200 degrees Celsius) in the two methods for bonding two materials is less than the bonding temperature required by conventional methods so that the methods of the present invention are suitable for materials that cannot withstand high temperature, and the methods can therefore avoid stresses caused by thermal expansion or cooling shrinkage and resulting in the damage of materials. Compared to conventional methods, the methods of the present invention can improve the manufacturing yield.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIGS. 1A to 1C are cross-sectional views showing a bonding method according to the first embodiment of the present invention;

FIGS. 2A to 2C are cross-sectional views showing a bonding method according to the second embodiment of the present invention;

FIGS. 3A to 3C are cross-sectional views showing a bonding method according to the third embodiment of the present invention; and

FIGS. 4A to 4C are cross-sectional views showing a bonding method according to the fourth embodiment of the present invention.

### DETAILED DESCRIPTION OF THE INVENTION

The present invention exemplarily demonstrates embodiments of a method for bonding two different semiconductor materials. In order to thoroughly understand the present invention, detailed descriptions of method steps and components are provided below. It should be noted that the implementations of the present invention are not limited to the specific details that are familiar to persons in the art related to semiconductor manufacturing processes, and such details are omitted to avoid unnecessary limitations to the present invention. On the other hand, components or method steps, which are well known, are not described in detail. A preferred embodiment of the present invention is described in detail below. However, in addition to the preferred detailed description, other embodiments can be broadly employed, and the scope of the present invention is not limited by any of the embodiments, but should be defined in accordance with the following claims and their equivalent.

The present invention provides a method for bonding two heterogeneous semiconductor materials. The method based on the behavior of magnetic inductance, which instantly induces an amount of heat in a high magnetic permeability material. The heat is transferred to a low melting bonding material so that the bonding material can be heated to a bonding temperature to bond the two semiconductor materials with different characteristics.

The bonding method of the present invention based on radio frequency heating method may also be applied to the bonding of two homogeneous semiconductor materials. The radio frequency heating method is a heating method based on the theory of magnetic inductance. A DC current flows through a metal spiral coil, inducing magnetic field and electrical field in a metal material disposed in the spiral coil. With the change of the magnetic field of the spiral coil, the electrical field simultaneously varies so that the electrons in the metal material are excited to produce eddy currents, and heat is generated due to the eddy currents and the resistance of the metal material.

According to the above-mentioned theory of magnetic inductance, a radio frequency heating system is designed. The heating system includes a cylindrical spiral coil and a DC voltage power supply, wherein the DC voltage power supply further comprises a power transistor, which can supply a high-frequency current of 20,000 cycles per second and can regularly and swiftly change the current flowing direction in the spiral coil so as to instantly induce a large amount of heat in a metal material disposed in the spiral coil due to the electromagnetic induction. Further, the heat generated in the metal material by the electromagnetic induction can be estimated from equation (1):

P=π×d×h×H²×\sqrt{π×ρ×μ₀×μᵣ×f}×C×F (1)

where d is the diameter of the spiral coil, h is the height of the spiral coil, H is magnetic field intensity, ρ is a resistivity, μ₀ is magnetic permeability of vacuum, μᵣ is a relative permeability, f is a frequency, C is a coupling factor, and F is a power transmission factor.

In equation (1), parameters μ₀ and μᵣ are related to the material in the spiral coil, and they are called “permeability.” If the parameters μ₀ or μᵣ is increased, the inductance of the material increases, and more heat is generated. In all metal materials, iron, cobalt and nickel have high magnetic permeability, and thus are suitable to be used as the catalyst in the radio frequency heating system of the present invention to swiftly heat up to a bonding temperature.

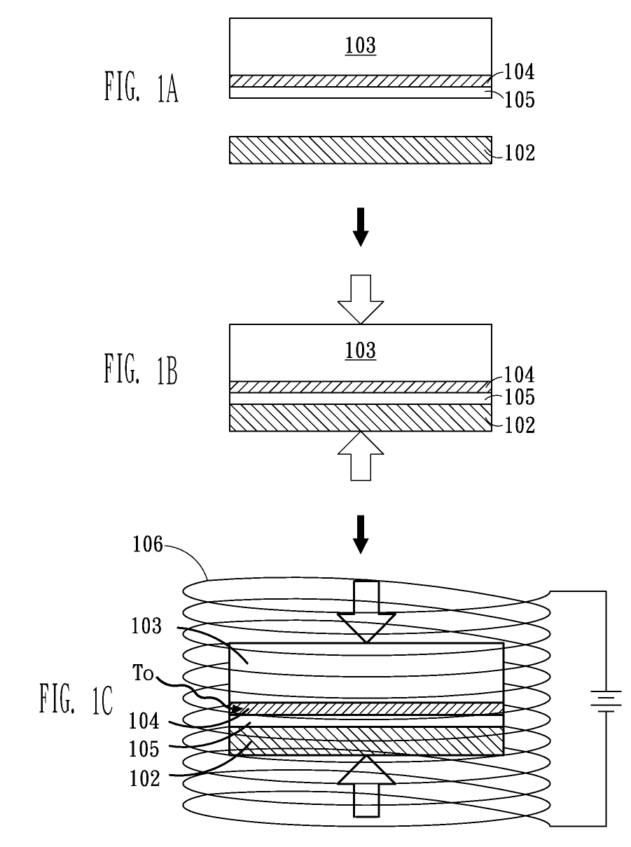

The present invention is related to a method for bonding two materials. The method uses a radio frequency heating system and a high magnetic permeability metal as a magnetic induction catalyst in combination of a low melting point metal material as a medium so that two materials can be bonded instantly at a low temperature. Referring to FIG. 1A, the elements used in the method of the present invention comprise a first material 103, a second material 102, a high magnetic permeability metal layer 104, and a medium metal layer 105, wherein the first material 103 and the second material 102 are the two elements to be bonded. The high magnetic permeability metal layer 104 is used as a magnetic induction catalyst, and the medium metal layer 105 is used as a bonding medium for bonding the first material 103 and the second material 102.

Referring to FIGS. 1A to 1C, the method of the present invention comprises the steps of: as shown in FIG. 1A, a high magnetic permeability metal layer 104 is disposed on the bonding surface of the first material 103. A flat surface of the high magnetic permeability metal layer 104 can be produced for being attached to another surface. The high magnetic permeability metal layer 104 is used as a catalyst for increasing temperature when electromagnetic energy is applied. The high magnetic permeability metal layer 104 mainly comprises high magnetic permeability metal material preferably including iron, cobalt, nickel or an alloy thereof. Moreover, according to equation P=π×d×h×H²×\sqrt{π×ρ×μ₀×μᵣ×f}×C×F, the adoption of alloys in different combinations of iron, cobalt, and nickel can be used to control the amount of generated heat.

Referring to FIG. 1A again, after the high magnetic permeability metal layer 104 is formed on the first material 103, a medium metal layer 105 is formed on the surface of the high magnetic permeability metal layer 104. A flat surface of the medium metal layer 105 can be produced for the next process. The metal layer 105 can comprise a metal having low melting point such as indium, tin, zinc, silver, and an alloy thereof. Such a metal layer 105 can reduce the time needed to increase the temperature thereof to a temperature of the metal layer 105 for bonding.

One of the aspects of the present invention is the medium metal layer 105. The medium metal layer 105 is heated to the bonding temperature thereof by the heat from the high magnetic permeability metal layer 104, induced by radio frequency energy, and at the interfaces between the medium layer 105 and the first material 103 and between the medium layer 105 and the second material 102, bonding forces are created. The bonding temperature can be below or equal to the melting point of the metal layer 105. Referring to FIG. 1B, before the metal layer 104 is heated by radio frequency energy, the first material 103 and the second material 102 are compressed by an external force (shown by up and down arrows) for fixing so that the metal layer 104 and the second material 102 can be firmly attached at the interface therebetween. Any press mechanism can accomplish the compressing process, and is not related to the technical features of the present invention. The compressing process is not further described in detail here.

Referring to FIG. 1C, the compressed first material 103 and second material 102 are sent to a radio frequency heating system 106 for heating by radio frequency energy. The radio frequency heating system 106 mainly comprises a spiral coil and a DC power supply, wherein the spiral coil is configured to contain the compressed first material 103 and second material 102, and the DC voltage power supply comprises a power transistor, which can supply a high-frequency current to the spiral coil.

In FIG. 1C, when high frequency current flows through the spiral coil, the temperature of the high magnetic permeability metal layer 104 disposed between the first material 103 and the second material 102 swiftly increases. Because the medium metal layer 105 is closely attached to the high magnetic permeability metal layer 104, the medium metal layer 105 is heated to the bonding temperature thereof so that the first material 103 and the second material 102 can be bonded via the medium metal layer 105. Finally, the radio frequency heating system 106 is stopped, and the temperature of the medium metal layer 105 is restored to room temperature.

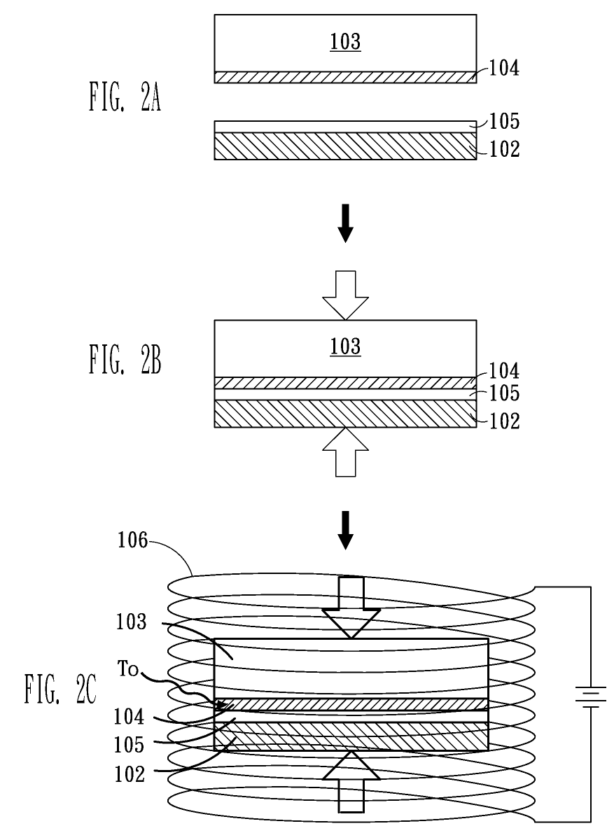

Referring to FIG. 2A, the present invention discloses another method for bonding two materials. The method steps are different from those of the above-mentioned method. To conveniently distinguish two bonding materials, the two materials are separately identified as a first material 103 and as a second material 102. In FIG. 2A, the method initially forms a high magnetic permeability metal layer 104 on a bonding surface of the first material 103. The high magnetic permeability metal layer 104 is configured as a catalyst for increasing temperature. The high magnetic permeability metal layer 104 is preferably selected from the group consisting of iron, cobalt, nickel and an alloy thereof. The high magnetic permeability metal layer 104 can have a flat surface for attachment of another surface.

In FIG. 2A, a medium metal layer 105 is formed on the second material 102, and may have a flat surface for the same purpose as described above. The metal layer 105 can preferably include a low melting point metal such as indium, tin, zinc, silver, or an alloy thereof so that the radio frequency heating system 106 can abruptly increase the temperature of the metal layer 105 to the bonding temperature of the metal layer 105. The bonding temperature is lower than the melting points of the first material 103 and the second material 102 so that the bonding temperature may not cause thermal damage to the first material 103 and the second material 102 and change the characteristics of the first material 103 and the second material 102.

In FIG. 2B, before the high magnetic permeability metal layer 104 is heated by radio frequency energy, the first material 103 and the second material 102 are pressed so that the high magnetic permeability metal layer 104 on the first material 103 and the medium metal layer 105 on the second material 102 are firmly attached at the interface therebetween. Next, the pressed first material 103 and second material 102 are sent to a radio frequency heating system 106 for heating T₀. The radio frequency heating system 106 can have a structure similar to the above-mentioned radio frequency heating system 106.

In FIG. 2C, when the radio frequency heating system 106 starts to operate and high frequency current flows through the spiral coil, the high magnetic permeability metal layer 104 between the first material 103 and the second material 102 is induced, with eddy currents generated therein so as to swiftly increase its temperature. Because the medium metal layer 105 is closely attached to the high magnetic permeability metal layer 104, the medium metal layer 105 is heated to its bonding temperature so that the first material 103 and the second material 102 are bonded. After the temperature is restored to room temperature, the bonding of the first material 103 and the second material 102 is finished.

In the embodiments of FIGS. 1A to 1C and FIGS. 2A to 2C, the first material 103 and the second material 102 can include a metal, wherein the first material 103 and the second material 102 may include copper, tungsten or an alloy, or semiconductor material with silicon. The first material 103 and the second material 102 can be the same metal. In FIGS. 1A and 2A, the high magnetic permeability metal layer 104 can be formed on the first material 103 using a physical vapor deposition process, an evaporation process, or a sputtering process.

Further referring to FIGS. 1A and 2A, a complimentary description of the formation of the medium metal layer 105 is provided herein. The medium metal layer 105 can be formed on the surface of the high magnetic permeability metal layer 104 or the second material 102 using a physical vapor deposition process, an evaporation process, or a sputtering process. The high magnetic permeability metal layer 104 is instantly heated by radio frequency energy, and the medium metal layer 105 is heated to generate bonding force between the first material 103 and the second material 102.

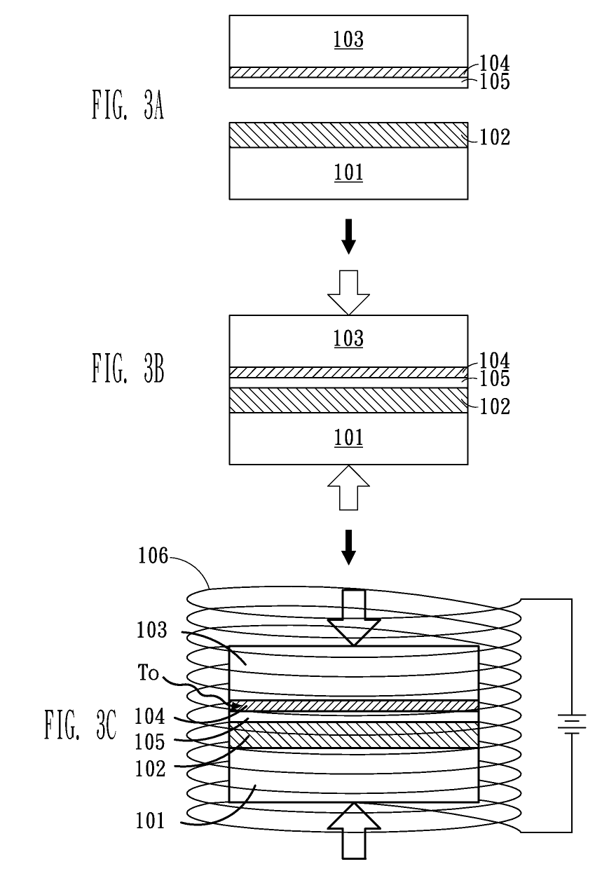

In many semiconductor manufacturing processes, two semiconductor materials are required to be bonded to each other, and the bonding method of the present invention can be applied for the semiconductor manufacturing processes. Referring to FIG. 3, in this embodiment, a first semiconductor material 103 is bonded to a second semiconductor material 102, wherein the first semiconductor material 103 and the second semiconductor material 102 may be gallium nitride (GaN), indium aluminum gallium nitride (InAlGaN), aluminum gallium indium phosphide (AlGaInP), or gallium arsenide (GaAs). The first semiconductor material 103 and the second semiconductor material 102 can be the same semiconductor material.

Referring to FIG. 3A, the second semiconductor material 102 can be formed using a substrate 101 by a semiconductor manufacturing process. The substrate 101 may be a sapphire (Al₂O₃) substrate, a silicon carbide (SiC) substrate, a lithium aluminate (LiAlO₂) substrate, a lithium gallates (LiGaO₂) substrate, a silicon substrate, a gallium nitride (GaN) substrate, a zinc oxide (ZnO) substrate, an aluminum zinc oxide (AlZnO) substrate, a gallium arsenide (GaAs) substrate, a gallium phosphide (GaP) substrate, a gallium antimonide (GaSb) substrate, an indium phosphide (InP) substrate, an indium arsenide (InAs) substrate, a zinc selenide (ZnSe) substrate, or a metal substrate. The selection of the substrate 101 of the second semiconductor material 102 depends on the semiconductor characteristics of the manufactured device.

The type of the substrate 101 is determined by the property of the second semiconductor material 102. For example, when manufacturing a II-VI compound semiconductor, a zinc selenide substrate or a zinc oxide substrate may be selected as an epitaxial substrate; when manufacturing a III-arsenide or III-phosphide compound semiconductor, a gallium arsenide substrate, a gallium phosphide substrate, an indium phosphide substrate, or an indium arsenide substrate may be selected as a substrate; and to manufacture a III-nitride compound semiconductor, a commercially-available sapphire substrate or a silicon carbide substrate may be selected. In the present experimental stages, a lithium aluminate substrate, a lithium gallates substrate, a silicon substrate, or an aluminum zinc oxide substrate is used. Furthermore, the lattice structure and the lattice constant are also important selection factors. When the difference of lattice constants is too large, a buffer layer is required to obtain a good quality of an epitaxial layer.

In the present embodiment, the second semiconductor material 102 can be III-nitride, and especially gallium nitride, and the substrate 101 used to manufacture the second semiconductor material 102 can be a commercially available sapphire substrate or silicon carbide substrate. However, persons skilled in the art can understand that the second semiconductor material 102 is not limited to the III-nitride, or even to gallium nitride. Any III-V compound semiconductor or II-VI compound semiconductor can be used in the present invention.

Referring to FIG. 3A, a high magnetic permeability metal layer 104 is disposed on the first semiconductor material 103 using a physical vapor deposition process, an evaporation process, or a sputtering process, and the high magnetic permeability metal layer 104 can have a flat surface. As mentioned above, the high magnetic permeability metal layer 104 may preferably include a material such as iron, cobalt, nickel, or an alloy thereof. The high magnetic permeability metal layer 104 is configured as a catalyst for increasing temperature based on P=π×d×h×H²×\sqrt{π×ρ×μ₀×μᵣ×f}×C×F, and the material cobalt and nickel is suitable as the catalyst.

Referring to FIG. 3A, after the high magnetic permeability metal layer 104 is disposed on the first semiconductor material 103, a medium metal layer 105 is formed on the high magnetic permeability metal layer 104 with a flat surface. The medium metal layer 105 can be formed using a physical vapor deposition process, an evaporation process, or a sputtering process. The medium metal layer 105 can use a low melting material such as indium, tin, zinc, silver, or an alloy thereof. Such medium metal layer 105 can reduce the time needed to increase the temperature thereof to a temperature suitable for bonding the high magnetic permeability metal layer 104.

One aspect of the present invention is that the first semiconductor material 103 and the second semiconductor material 102 are bonded by a melted medium metal layer 105 therebetween. Therefore, in FIG. 3B, the high magnetic permeability metal layer 104 is not heated by radio frequency energy; rather the first and second semiconductor materials 103 and 102 are pressed by an external force (shown by up and down arrows) for fixing so that the high magnetic permeability metal layer 104 and the second semiconductor material 102 can be firmly attached at the interface therebetween. Any pressing mechanism can accomplish the pressing process, and is not further described in detail in here.

Referring to FIG. 3C, the fixed first and second semiconductor material 103 and 102 are sent to a radio frequency heating system 106 for heating by radio frequency energy. The radio frequency heating system 106 mainly comprises a spiral coil and a DC power supply, wherein the spiral coil is configured to contain the fixed first and second semiconductor material 103 and 102, and the DC voltage power supply, similar to the disclosures in FIGS. 1A to 1C and 2A to 2C, can supply high frequency current to the spiral coil.

In FIG. 3C, the radio frequency heating system 106 uses the DC power supply to provide high frequency current to the spiral coil. A current is induced in the high magnetic permeability metal layer 104 between the first material 103 and the second material 102, with eddy currents generated therein. A high amount of heat is generated in the high magnetic permeability metal layer 104 due to the eddy currents and the resistance of the high magnetic permeability metal layer 104. Because the medium metal layer 105 is closely attached to the high magnetic permeability metal layer 104, the medium metal layer 105 is heated to its bonding temperature so that the first material 103 and the second material 102 are bonded.

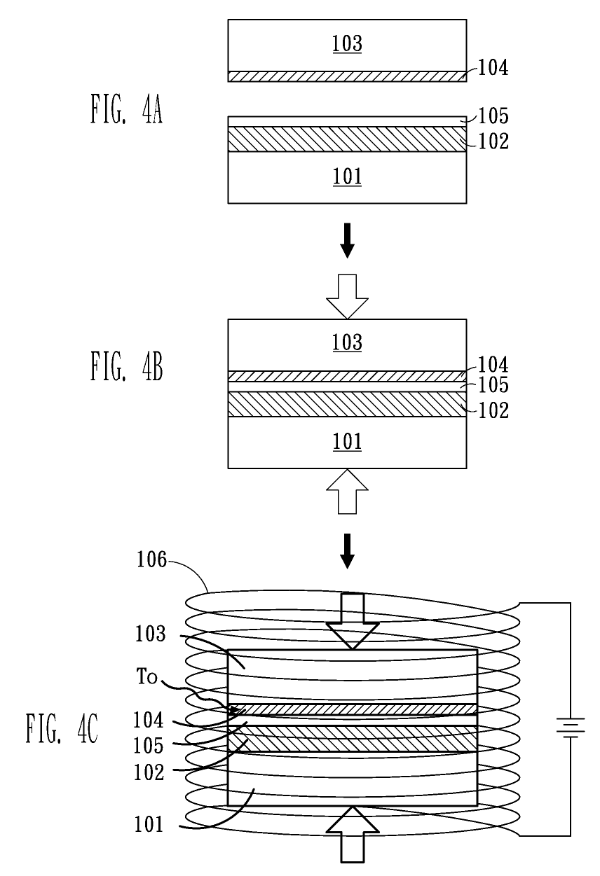

Referring to FIGS. 4A to 4C, the present invention provides another method for bonding two semiconductor materials. The first semiconductor material 103 and the second semiconductor material 102 are used for distinguishable explanations. The first semiconductor material 103 and the second semiconductor material 102 can be gallium nitride, indium aluminum gallium nitride, aluminum gallium indium phosphide, or gallium arsenide. Clearly, the first semiconductor 103 and the second semiconductor material 102 can be the same material under certain situations.

Referring to FIG. 4A, the high magnetic permeability metal layer 104 can be formed on the first semiconductor material 103 using a physical vapor deposition process, an evaporation process, or a sputtering process. The high magnetic permeability metal layer 104 can preferably be iron, cobalt, nickel, or an alloy thereof. After the high magnetic permeability metal layer 104 is finished, its surface can be planar for attachment of another surface.

The second semiconductor material 102 is epitaxially formed on a substrate 101 in a semiconductor process as shown in FIG. 3. The substrate 101 may be a sapphire (Al₂O₃) substrate, a silicon carbide (SiC) substrate, a lithium aluminate (LiAlO₂) substrate, a lithium gallates (LiGaO₂) substrate, a silicon substrate, a gallium nitride (GaN) substrate, a zinc oxide (ZnO) substrate, an aluminum zinc oxide (AlZnO) substrate, a gallium arsenide (GaAs) substrate, a gallium phosphide (GaP) substrate, a gallium antimonide (GaSb) substrate, an indium phosphide (InP) substrate, an indium arsenide (InAs) substrate, or a zinc selenide (ZnSe) substrate. The formation of the second semiconductor material 102 is as shown in FIG. 3.

Referring to FIG. 4A, a medium metal layer 105 is formed on a surface of the second semiconductor material 102 using a physical vapor deposition process, an evaporation process, or a sputtering process. The medium metal layer 105 can use a material such as indium, tin, zinc, silver, or an alloy thereof. The above-mentioned materials have a melting point lower than the melting point of the first and second semiconductor materials 103 and 102. As such, the heat used to cause the medium metal layer 105 to develop bonding forces does not damage the first and second semiconductor materials 103 and 102.

In FIG. 4B, the high magnetic permeability metal layer 104 on the first semiconductor material 103 and the medium metal layer 105 on the second semiconductor material 102 are brought in contact with each other by an external force (shown by up and down arrows).

In FIG. 4C, the prepared bonding first and second semiconductor materials 103 and 102 are sent to a radio frequency heating system 106 for heating by radio frequency energy. The structure of the radio frequency heating system 106 is similar to the above-mentioned embodiments, comprising a cylindrical spiral coil and a DC voltage power supply, wherein the spiral coil is configured to contain the fixed first and second semiconductor materials 103 and 102. The power transistor in the DC voltage power supply can supply high frequency DC current to the spiral coil.

The radio frequency heating system 106 induces an eddy current effect on the high magnetic permeability metal layer 104 so that a high amount of heat is generated in the high magnetic permeability metal layer 104. The average temperature of the high magnetic permeability metal layer 104 can be below 200 degrees Celsius. Because the medium metal layer 105 disposed on the second semiconductor material 103 is close to the high magnetic permeability metal layer 104 and is a material with a low melting point, the temperature of the medium metal layer 105 is increased by the heat to the bonding temperature of the medium metal layer 105 so that the medium metal layer 105 and the high magnetic permeability metal layer 104 on the first semiconductor materials 103 are bonded, and therefore the first and second semiconductor materials 103 and 102 are bonded.

In the above-mentioned embodiments, for either the method demonstrated in FIGS. 1A to 1C and 2A to 2C or the method demonstrated in FIGS. 3A to 3C and 4A to 4C, the first material 103 and the second material 102 are not limited to using the same metal material or using the same semiconductor material. The first material 103 and the second material 102 can separately be a metal or a semiconductor material. In addition, the medium layer 105 used to bond the first and second materials 103 and 102 is not limited to a medium metal layer 105, but can be alternatively a non-metallic material. The bonding temperature will not affect the original properties of the first and second materials 103 and 102. Using a radio frequency heating method and a high magnetic permeability material can achieve a lower bonding temperature (less than 200 degrees Celsius) and a fast bonding effect. Moreover, the stresses caused by thermal expansion or cooling shrinkage can be avoided, lowering the risk of breakage and warpage of semiconductor materials, or production of inferior physical characteristics of semiconductor materials. Compared to conventional bonding methods, the bonding method of the present invention can improve the manufacturing yield.

The above-described embodiments of the present invention are intended to be illustrative only. Numerous alternative embodiments may be devised by persons skilled in the art without departing from the scope of the following claims.

What is claimed is:

1. A method for bonding two materials, comprising steps of:
forming a high magnetic permeability metal layer on a first material layer;
forming a medium layer on said high magnetic permeability metal layer;
bringing a second material layer in contact with said medium layer; and
inducing heat in said high magnetic permeability metal layer by radio frequency energy to heat said medium layer to a bonding temperature of said medium layer so as to bond said second material layer to said medium layer.

2. The method of claim 1, wherein an average temperature of said first material layer and said second material layer is below 200 degrees Celsius when said medium layer is being bonded to said second material layer.

3. The method of claim 1, wherein the material of said first material layer is a semiconductor material or a metal.

4. The method of claim 3, wherein said material of said first material layer is copper, tungsten or an alloy thereof, or said material of said first material layer is silicon.

5. The method of claim 1, wherein the material of said second material layer is a semiconductor material or a metal.

6. The method of claim 1, wherein the material of said medium layer is a low melting point metal.

7. The method of claim 6, wherein said material of said medium layer is indium, tin, zinc, silver, or an alloy thereof.

8. The method of claim 1, wherein said high magnetic permeability metal layer comprises ferromagnetic materials.

9. The method of claim 8, wherein the material of said high magnetic permeability metal layer is iron, cobalt, nickel or an alloy thereof.

10. The method of claim 1, wherein said high magnetic permeability metal layer is heated by eddy currents induced by a radio frequency heating system including a spiral coil, and said high magnetic permeability metal layer is heated according to an equation as follows:
P=π×d×h×H²×\sqrt{π×ρ×μ₀×μᵣ×f}×C×F
where d is the diameter of said spiral coil, h is the height of said spiral coil, H is magnetic field intensity, ρ is a resistivity, μ₀ is magnetic permeability of vacuum, μᵣ is a relative permeability, f is a frequency, C is a coupling factor, and F is a power transmission factor.

11. A method for bonding two materials, comprising steps of:
forming a high magnetic permeability metal layer on a first material layer, and a medium layer on a second material layer; and
bringing said high magnetic permeability metal layer in contact with said medium layer, and inducing heat in said high magnetic permeability metal layer by radio frequency energy to heat said medium layer to a bonding temperature of said medium layer so as to bond said high magnetic permeability metal layer to said medium layer.

12. The method of claim 11, wherein an average temperature of said first material layer and said second material layer is below 200 degrees Celsius when said medium layer is being bonded to said high magnetic permeability metal layer.

13. The method of claim 11, wherein the material of said first material layer is a semiconductor material or a metal.

14. The method of claim 13, wherein said material of said first material layer is copper, tungsten or an alloy thereof, or said material of said first material layer is silicon.

15. The method of claim 11, wherein the material of said second material layer is a semiconductor material or a metal.

16. The method of claim 11, wherein the material of said medium layer is a low melting point metal.

17. The method of claim 16, wherein said material of said medium layer is indium, tin, zinc, silver, or an alloy thereof.

18. The method of claim 11, wherein said high magnetic permeability metal layer comprises ferromagnetic materials.

19. The method of claim 18, wherein the material of said high magnetic permeability metal layer is iron, cobalt, nickel or an alloy thereof.

20. The method of claim 11, wherein said high magnetic permeability metal layer is heated by eddy currents induced by a radio frequency heating system including a spiral coil, and said high magnetic permeability metal layer is heated according to an equation as follows:
P=π×d×h×H²×\sqrt{π×ρ×μ₀×μᵣ×f}×C×F
where d is the diameter of said spiral coil, h is the height of said spiral coil, H is magnetic field intensity, ρ is a resistivity, μ₀ is magnetic permeability of vacuum, μᵣ is a relative permeability, f is a frequency, C is a coupling factor, and F is a power transmission factor.
